(19) United States
(12) Patent Application Publication
(10) Pub. No.: US 2005/0256859 A1
(43) Pub. Date: Nov. 17, 2005

(54) System, application and method of providing application programs continued access to frozen file systems

(75) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: Mr. Volel Emile, P.O. Box 202170, Austin, TX, 78720-2170, US

(73) Assignee: Internation Business Machines Corporation

(21) Appl. No.: 10/845,563

(22) Filed: May 13, 2004

(51) Int. Cl. G06F 17/30

(52) U.S. Cl. 707/4

(57) ABSTRACT

A system, apparatus and method of allowing an application program continued access to a frozen file system are provided. An application program that requires continued access to a file system, even when the file system is frozen, may register with the system. Doing so allows the system to identify application program as one that needs continued access to the file system. Hence, the application program may continue to be provided access to the file system while all other application programs are prevented from accessing the file system.

### BACKGROUND OF THE INVENTION

1. Technical Field

The present invention is directed to file systems. More specifically, the present invention is directed to a system, application and method of providing an application program continued access to a frozen file system.

2. Description of Related Art

A snapshot is a copy of stored data at a specified point in time. One reason a user may want to take a snapshot is to restore data after running a test that may have modified the data. For example, suppose a user wants to execute an application, evaluate any result that the application may produce and then discard changes the application may have made to the stored data, the user may want to take a snapshot of the data before executing the application. After the result has been evaluated, the user may restore the original data by replacing the data in the storage system with the snapshot taken earlier.

Before taking a snapshot of the data, however, it is highly advisable that a “freeze” operation be performed on the file system. A “freeze” operation flushes any dirty buffers (i.e., buffers containing metadata and/or user data that has been modified) in the file system cache to the physical storage system and then suspends new activity on the file system until a “thaw” operation is performed. If a “freeze” operation is not performed on the file system before taking a snapshot, one of the following cases may occur:
(1) a minimal log replay may be required, in which changes from a journal are applied to the file system. This is generally not a time-consuming operation;
(2) a full file system sanity check may be needed before the file system is returned to a usable state. This check may take from minutes to hours depending on the size of the file system, during which time the file system will be inaccessible;
(3) the file system may become completely unusable and all data lost.

Thus, it is prudent to perform a “freeze” operation before taking a snapshot of the data.

With the advent of high capacity (e.g., one or more terabytes) storage devices, a multiplicity of application programs may share one file system. Obviously, when frozen none of these applications programs may read from or write to the file system. Nonetheless, there are certain application programs that should never be frozen out of a file system. For example, a bank database that supports customer services, such as ATM (Automatic Teller Machine) may need to have constant access to the stored data. Basically, any mission critical application programs should not be frozen out of a file system.

Therefore, what is needed is a system, application and method of providing certain application programs continued access to frozen file systems.

### SUMMARY OF THE INVENTION

The present invention provides a system, apparatus and method of providing an application program continued access to a frozen file system. An application program that requires continued access to a file system, even when the file system is frozen, may register with the system. Doing so allows the system to identify the application program as one that needs continued access to the file system. Hence, the application program may continue to be provided access to the file system while all other application programs are prevented from accessing the file system.

Before freezing the file system, however, the application program may be put in a backup mode. This enables the application program to enter into a transactional log all data that is being written into the file system during the freeze. This feature is rather important when snapshots are taken. Particularly, since data may be written in the file system by the application program during a freeze, data written before the freeze is initiated will be in the snapshot while data written during the freeze will not. In order for the snapshot to have data that is consistent with the file system after the freeze, data written into the file system during the freeze should be included in the snapshot. Thus, after the file system is unfrozen, the data in the transactional log is entered into the snapshot.

In some cases, however, an application program may decide that it does not need to be part of a snapshot. In other cases, the application may decide that if it is not put into backup mode prior to the start of a snapshot, the application data is not the object of the backup. In such instances, the application data written into the file system by the application will not be in a usable or consistent state in the snapshot.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a conceptual view of an LVM.

FIG. 2a depicts an exemplary “open” command.

FIG. 2b depicts an exemplary “IOCTL” command.

FIG. 2c shows an exemplary “FCNTL” command.

FIG. 3 is a flowchart of a process that may be used to implement the invention.

FIG. 4 is a flowchart of a process that may be used by application programs that handle their own in-time backups.

FIG. 5 is an exemplary block diagram of a computer system in which the invention may be implemented.

### DETAILED DESCRIPTION OF THE PREFERRED EMBODIMENT

A file system is a collection of directories and files. Some system (e.g., a Unix system) may contain more than one file system. Each file system does not have to exist on a single storage device (e.g., hard disk). One hard disk may contain several file systems or a single file system may be spread across multiple hard disks. The present invention will be explained using one file system spread across multiple hard disks. However, it should be understood that the invention is not restricted to such configuration.

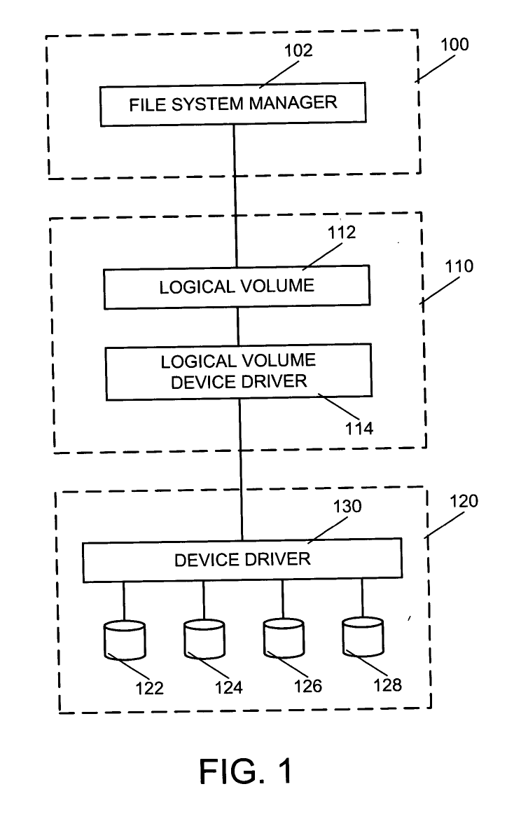

With reference now to the figures, FIG. 1 depicts a conceptual view of a storage system. The storage system includes a logical volume manager (LVM) which interacts with application programs and the physical storage devices as shown in FIG. 1. In FIG. 1 three layers (i.e., an application layer 100, a logical layer 110 and a physical layer 120) are depicted. Each one of the layers is shown to have one or more devices. It should be noted that the devices shown in the three layers are not all-inclusive. There may be more devices in use in each of the application layer 100, the logical layer 110 and the physical layer 120. Thus, the devices in FIG. 1 should be taken only as an example of devices that may be used in a storage system.

The logical layer 110, for all intent and purpose, is the LVM. The LVM may be regarded as being made up of a set of operating system commands, library subroutines or other tools that allow a user to establish and control logical volume storage. The LVM controls physical storage system resources by mapping data between a simple and flexible logical view of storage space and the actual physical storage system. The LVM does this by using a layer of device driver code that runs above traditional device drivers. This logical view of the disk storage is provided to application programs and is independent of the underlying physical disk structure.

The logical layer 110 contains a logical volume 112 that interacts with logical volume device driver 114. A device driver, as is well known in the art, acts as a translator between a device and programs that use the device. That is, the device driver accepts generic commands from programs and translates them into specialized commands for the device. In this case, the logical volume device driver 114 translates commands from an application program that may be executing on the computer system for device driver 130. Thus, when an application program sends commands to file system manager 102 to store or retrieve data from logical volume 112, the file system manager 102 informs the logical volume 112 of the application program's wish. The logical volume 112 then conveys the wish to the logical volume device driver 114. The logical volume device driver 114 then instructs the device driver 130 which ones of physical storage systems 122, 124, 126 and 128 to use to store or to retrieve the data.

In some instances, a storage manager (not shown) may be used in conjunction with FIG. 1. A storage manager, such as IBM Tivoli Storage Manager, may provide a full range of capabilities including infrastructure management, archive management, recovery management, and Hierarchical Storage Management (HSM) underpinned with block and file virtualization, that can be part of a total end-to-end solution for both active and inactive data management.

Thus, when a snapshot is needed, the storage manager may instruct the file system manager 102 to freeze the file system and to take a snapshot of the data. However, as mentioned before, some application programs should not be frozen out of the file system. The present invention enables an application program to bypass a file system freeze operation.

Some application programs, such as databases, which handle user data, may perform their own in-time backups. Backups are copies of active online data stored on offline storage devices. Should an online storage device fail, a data error occur or someone accidentally delete a file, an offline copy of the data can be copied or restored to the online storage device. In accordance with the invention, all application programs that perform their own in-time backups may register with the storage manager. The storage manager may instruct the registered application programs to go on backup mode before it issues the freeze command to the file system manager 102.

Before going on backup mode, the registered application programs may have to indicate to the file system manager 102 the file or files from which they wish to continue to read data and/or to which they wish to continue to write data. Generally, while the file system is frozen, data may continue to be written to blocks of space that have already been allocated and/or committed to the programs.

The indication of the files may be done via a variety of ways. For example, the registered application programs may add an extended attribute to the files they wish to continue to access during the file system freeze. As background information, file attributes are information about a file that is maintained by the operating system outside the file's overt storage area. The attributes may be used to indicate whether the file is a read-only file, a system file, a hidden file, an archive file etc. File attributes are actually stored as bit flags in the file's directory entry.

An extended attribute (EA) is additional non-user data that is associated with the file. In most systems, very little restrictions are placed on contents of extended attributes. Hence, any application program may attach an extended attribute to any object file. The attached extended attribute may or may not have meaning outside of that application.

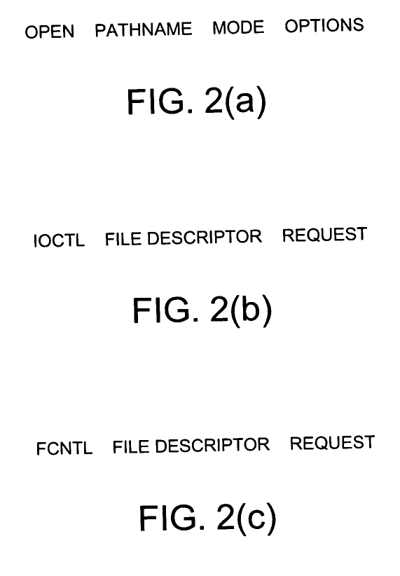

Alternatively, when the registered application programs are opening a file into which they wish to continue to have access during a file system freeze, they may add an i_ignore_freeze as one of the options or flags to the “open” command. FIG. 2a depicts an exemplary “open” command. One of the attributes of the “open” command is the name of the file (shown as pathname), another attribute is the mode (i.e., whether the file is being open for reading or writing or both). Other attributes include a plurality of options. One of these options may be the i_ignore_freeze option.

Or, the registered application programs may issue an IOCTL or FCNTL command each time they open a file or each time they go on backup mode. If the registered application programs issue the IOCTL or FCNTL command when going on backup mode, then they have to turn the option off when they go off backup mode. They may do so by re-issuing the IOCTL or FNCL command.

In any event, IOCTL is used to perform a variety of control functions on streams devices while FCNTL provides for control over open files. FIG. 2b depicts an exemplary “IOCTL” command and FIG. 2c shows an exemplary “FCNTL” command. Both commands have a file descriptor attribute specifying a file in particular and a request. The request may be the i_ignore_freeze option.

When the registered application programs try to write into a file with the extended attribute or when the i_ignore_freeze option is passed to the file system manager 102, the file system manager 102 will allow the application program that uses the option to continue to read and/or to write in the indicated file during a file system freeze.

Most application programs that perform their own in-time backups, generally maintain a transactional log into which all data transactions are entered while the programs are in backup mode. This transactional log may be used to synchronize the data in a snapshot with data in a storage system that continues to be accessible by a registered application program during a freeze operation.

For example, suppose a freeze command is issued in order to take a snapshot of the data in a storage system. More over, suppose that when the freeze command was issued a registered application program was in the process of writing data into a file. Suppose further that the data was being written through five write operations and when the freeze command was issued only two write operations had been performed. Then, the snapshot will only include data written into the file through the first two write operations and not the data written into the file through the other three write operations. In other words, some of the data may be frozen in the snapshot while some other data may be frozen out of the snapshot. Thus, the state of the data may be unknown.

According to the invention, data in a transactional log may be entered into a snapshot to ensure that data in the snapshot is accurate. Particularly, after an application program comes out of a backup mode, which will occur after the file system has been unfrozen or thawed, a check may be done to determine whether there was data written in the transactional log during the file system freeze. If so, the data may be imported into the snapshot. This is commonly referred to as replaying the transaction log.

In some instances, a registered application program may, if so configured, opt altogether out of snapshots. When that occurs, data in files identified by the registered application program will be included in a snapshot; but, the data will be in an unknown state to the application and thus unusable as a backup. This would be commonly used by a database application so that when the database itself is not the target of the backup, the database is not frozen.

Note that the invention was described using a storage manager to instruct the registered application programs to go to backup mode as well as to instruct the file system manager 102 to freeze the file system and to take a snapshot of the data. However, any or all parts of the invention described above may be performed manually by a user. Thus, the use of the storage manager is for illustrative purposes only.

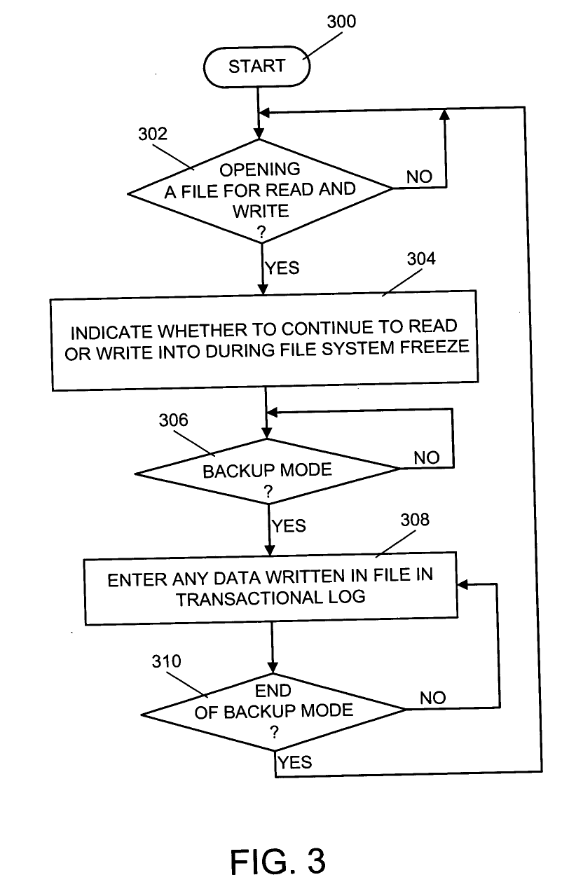

FIG. 3 is a flowchart of a process that may be used by application programs that handle their own in-time backups. The process starts when the application program starts to run (step 300). Then, a check is continually being made to determine whether the application program is opening a file for reading and writing. If so, the application program will notify the file system manager 102 whether it wishes to continue to read and/or write into the file while the file system is frozen. As mentioned earlier, this may be done using an extended attribute, the “open”, IOCTL or the FCNTL command. Note that by using an extended attribute the application program only needs to do so once (e.g., at the time the file is created). Also note that the IOCTL and the FCNTL commands may be used each time the application program is going to enter into backup mode or when it opens the file for reading and/or writing (steps 302 and 304).

The application program will continually check to see whether it is to enter into backup mode (step 306). If so, the application program will go into backup mode and enter into a transactional log any data that is being written into the file until it is out of the backup mode (steps 308 and 310). The process may end when the application program stops executing.

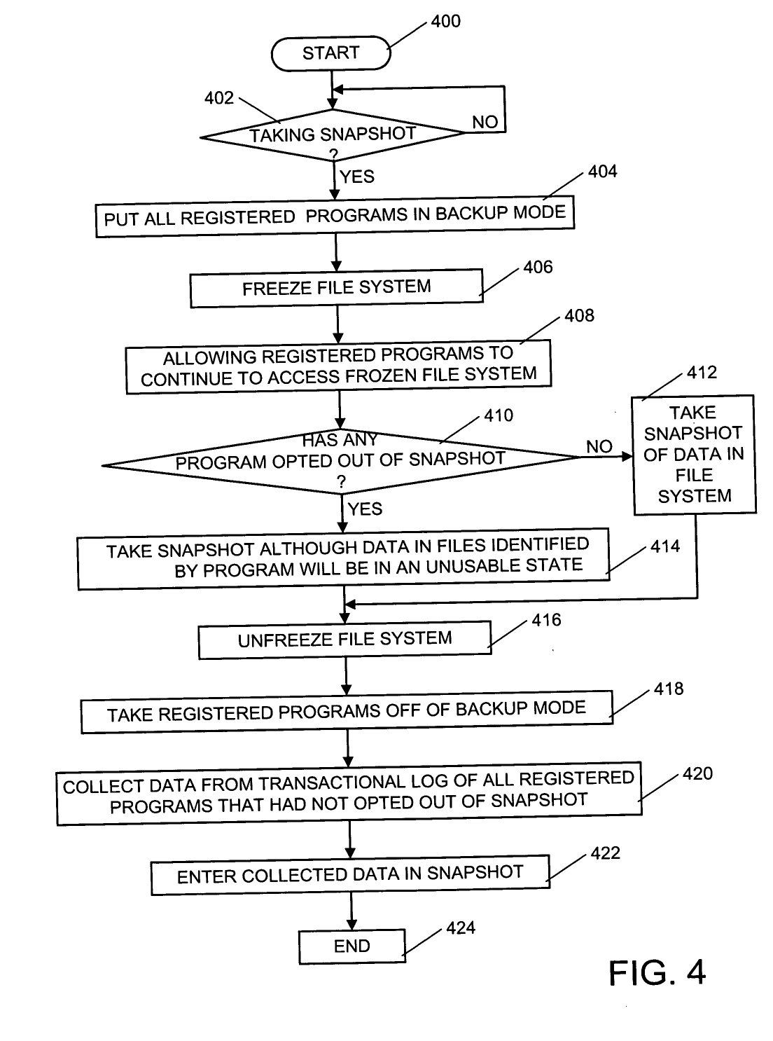

FIG. 4 is a flowchart of a process that may be used to implement the invention. The process starts when a snapshot of data in a storage system is needed (steps 400 and 402). At that point, the storage manager may put all registered application programs in backup mode (step 404). Ordinarily, when in backup mode, these application programs will keep a transactional log of all new data that is being written. After putting the registered application programs in backup mode, the storage manager may freeze out the file system manager (step 406). As mentioned before, although the file system is frozen, the registered application programs will have authorization to continue to access the file system to read and write data into blocks of space that have already been allocated to the application programs. In any case, before taking the snapshot, a check may be made to determine whether any of the registered application programs have opted out of snapshots. If so, data in files identified by those registered application programs will not be included in the snapshot (steps 408 and 410).

If not, a snapshot of all data in the file system will be taken (steps 408 and 412). After the snapshot has been taken, the file system may be unfrozen or thawed (step 414). When the file system is unfrozen, the registered application programs may be taken off the backup mode (step 416). At that time, data in the transactional log of all registered application programs that have not opted out of the snapshot may be collected and entered into the snapshot before the process ends (steps 418-422).

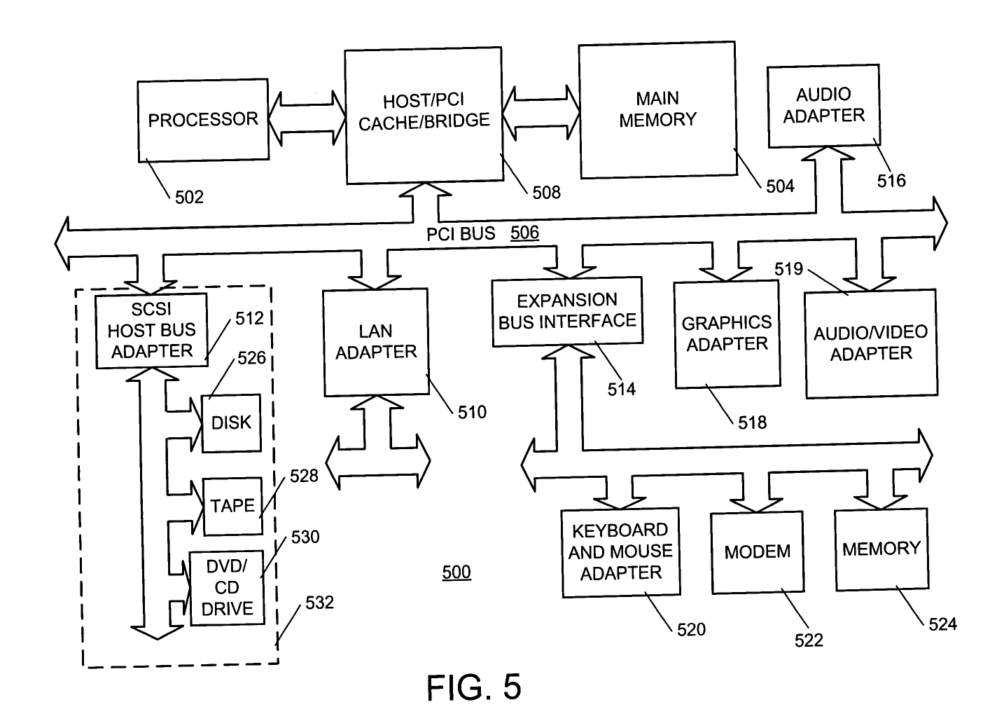

With reference now to FIG. 5, a block diagram illustrating a data processing system is depicted in which the present invention may be implemented. Data processing system 500 employs a peripheral component interconnect (PCI) local bus architecture. Although the depicted example employs a PCI bus, other bus architectures such as Accelerated Graphics Port (AGP) and Industry Standard Architecture (ISA) may be used. Processor 502 and main memory 504 are connected to PCI local bus 506 through PCI bridge 508. PCI bridge 508 also may include an integrated memory controller and cache memory for processor 502. Additional connections to PCI local bus 506 may be made through direct component interconnection or through add-in boards. In the depicted example, local area network (LAN) adapter 510, SCSI host bus adapter 512, and expansion bus interface 514 are connected to PCI local bus 506 by direct component connection. In contrast, audio adapter 516, graphics adapter 518, and audio/video adapter 519 are connected to PCI local bus 506 by add-in boards inserted into expansion slots. Expansion bus interface 514 provides a connection for a keyboard and mouse adapter 520, modem 522, and additional memory 524. Small computer system interface (SCSI) host bus adapter 512 provides a connection for hard disk drive 526, tape drive 528, and CD-ROM/DVD drive 530. Typical PCI local bus implementations will support three or four PCI expansion slots or add-in connectors.

An operating system runs on processor 502 and is used to coordinate and provide control of various components within data processing system 500 in FIG. 5. The operating system may be a commercially available operating system, such as Windows XP™, which is available from Microsoft Corporation. An object oriented programming system such as Java may run in conjunction with the operating system and provide calls to the operating system from Java programs or applications executing on data processing system 500. “Java” is a trademark of Sun Microsystems, Inc. Instructions for the operating system, the object-oriented operating system, and applications or programs are located on storage devices, such as hard disk drive 526, and may be loaded into main memory 504 for execution by processor 502.

Those of ordinary skill in the art will appreciate that the hardware in FIG. 5 may vary depending on the implementation. Other internal hardware or peripheral devices, such as flash ROM (or equivalent nonvolatile memory) or optical disk drives and the like, may be used in addition to or in place of the hardware depicted in FIG. 5. Also, the processes of the present invention may be applied to a multiprocessor data processing system.

The depicted example in FIG. 5 and above-described examples are not meant to imply architectural limitations. For example, data processing system 500 may also be a notebook computer or hand held computer or a PDA. Data processing system 500 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of providing an application program continued access to a frozen file system comprising the steps of:
identifying the application program; and
freezing the file system to prevent all other application programs from accessing the file system while providing the identified application program continued access to the file system.

2. The method of claim 1 wherein the step of identifying the application program includes the step of enabling the application program to register with a storage manager.

3. The method of claim 1 further including the step of putting the identified program in backup mode before allowing the program to continue to access the file system, the identified program entering data being written in the file system in a transactional log.

4. The method of claim 3 further including the step of determining, when a snapshot is being taken, whether the identified application program has indicated that its data is not to be part of the snapshot.

5. The method of claim 4 wherein if the data of the identified application program is to be part of the snapshot, after the registered application program comes out of the backup mode, the data in the transactional log is entered in the snapshot.

6. A computer program product on a computer readable medium for providing an application program continued access to a frozen file system comprising:
code means for identifying the application program; and
code means for freezing the file system to prevent all other application programs from accessing the file system while providing the identified application program continued access to the file system.

7. The computer program product of claim 6 wherein the code means for identifying the application program includes code means for enabling the application program to register with a storage manager.

8. The computer program product of claim 6 further including code means for putting the identified program in backup mode before allowing the program to continue to access the file system, the identified program entering data being written in the file system in a transactional log.

9. The computer program product of claim 8 further including code means for determining, when a snapshot is being taken, whether the identified application program has indicated that its data is not to be part of the snapshot.

10. The computer program product of claim 9 wherein if the data of the identified application program is to be part of the snapshot, after the registered application program comes out of the backup mode, the data in the transactional log is entered in the snapshot.

11. An apparatus for providing an application program continued access to a frozen file system comprising:
means for identifying the application program; and
means for freezing the file system to prevent all other application programs from accessing the file system while providing the identified application program continued access to the file system.

12. The apparatus of claim 11 wherein the identifying means includes means for enabling the application program to register with a storage manager.

13. The apparatus of claim 11 further including means for putting the identified program in backup mode before allowing the program to continue to access the file system, the identified program entering data being written in the file system in a transactional log.

14. The apparatus of claim 13 further including means for determining, when a snapshot is being taken, whether the identified application program has indicated that its data is not to be part of the snapshot.

15. The apparatus of claim 14 wherein if the data of the identified application program is to be part of the snapshot, after the registered application program comes out of the backup mode, the data in the transactional log is entered in the snapshot.

16. A system for providing an application program continued access to a frozen file system comprising:
at least one storage device for storing code data; and
at least one processor for processing the code data to identify the application program, and to freeze the file system to prevent all other application programs from accessing the file system while providing the identified application program continued access to the file system.

17. The system of claim 16 wherein the code data is further processed to enable the application program to register with a storage manager.

18. The system of claim 16 wherein the code data is further processed to put the identified program in backup mode before allowing the program to continue to access the file system, the identified program entering data being written in the file system in a transactional log.

19. The system of claim 18 wherein the code data is further processed to determine, when a snapshot is being taken, whether the identified application program has indicated that its data is not to be part of the snapshot.

20. The system of claim 19 wherein if the data of the identified application program is to be part of the snapshot, after the registered application program comes out of the backup mode, the data in the transactional log is entered in the snapshot.
